(19) United States
(12) Patent Application Publication
(10) Pub. No.: US 2026/0171692 A1
(43) Pub. Date: Jun. 18, 2026

(54) TERMINAL BLOCK

(71) Applicant: HIROSE ELECTRIC CO., LTD., Kanagawa (JP)

(72) Inventor: Hiromasa SATO, Kanagawa (JP)

(21) Appl. No.: 19/416,969

(22) Filed: Dec. 11, 2025

(30) Foreign Application Priority Data
Dec. 13, 2024 (JP) 2024-218434
Sep. 19, 2025 (JP) 2025-156306

(51) Int. Cl. H01R 9/24

(52) U.S. Cl. CPC H01R 9/2416

(57) ABSTRACT

A terminal block for connecting a plate-shaped connection terminal provided at one end of a conducting wire gripped by a user during connection work includes a housing; and an energizing member the housing, the energizing member having a surface erected toward a connection work side of the connection terminal by the user; and an opposing member in the housing in a state of opposing the surface, the opposing member forming, between the opposing member and the surface, a gap into which the connection terminal is inserted, the gap being opened on a connection work side of the connection terminal, in which the connection terminal is inserted into the gap along an insertion direction with one plate surface of the connection terminal facing the surface.

### CROSS-REFERENCE TO RELATED APPLICATION

This application claims priority from Japanese Patent Application No. 2025-156306 filed with the Japan Patent Office on Sep. 19, 2025, the entire content of which is hereby incorporated by reference.

### BACKGROUND

### 1. Technical Field

The present disclosure relates to a terminal block to which a plate-shaped connection terminal provided at one end of a conducting wire gripped by a user during connection work can be connected.

### 2. Related Art

Up to now, in connection work of connecting a connection terminal provided at one end of a conducting wire cable, for example, a round plate-shaped connection terminal provided with a through hole at the center to a terminal block, for example, as disclosed in JP-A No. 2002-343460, a connection terminal provided at one end of a conducting wire gripped by a user is moved substantially in parallel so as to be brought into surface contact with a connection surface of the terminal block from a connection work side where the user is located toward a bus bar which is an energizing member provided on the terminal block, and then brought into surface contact with the connection surface of the terminal block, and then the connection terminal is screwed using the through hole provided in the connection terminal, or as disclosed in JP-A-7-22085, a distal end of an outer peripheral edge of a circular connection terminal located at the outermost end of the conducting wire is inserted into a gap formed by the energizing members of a pair of the terminal blocks, A pin is made to pass through the through hole of the connection terminal.

### SUMMARY

According to the present disclosure, there is provided a terminal block capable of connecting a plate-shaped connection terminal provided at one end of a conducting wire gripped by a user during connection work, the terminal block including: a housing; an energizing member installed in the housing, the energizing member having a surface erected toward a connection work side of the connection terminal by the user; and an opposing member provided in the housing in a state of opposing the surface, the opposing member forming, between the opposing member and the surface, a gap into which the connection terminal is inserted, the gap being opened on a connection work side of the connection terminal by the user, in which the connection terminal is inserted into the gap along an insertion direction with one plate surface of the connection terminal facing the surface.

### BRIEF DESCRIPTION OF DRAWINGS

FIG. 1 is a perspective view illustrating an example of a usage mode of a terminal block according to an embodiment of the present disclosure, and is a view including a connection terminal that is not connected to the terminal block;

FIG. 2 is a perspective view illustrating an example of a usage mode of the terminal block according to the embodiment of the present disclosure, and is a view including a connection terminal in a state of being connected to the terminal block;

FIG. 3 is a perspective view illustrating a state of the conducting wire and the connection terminal in the usage mode of FIG. 2 together with some components of the terminal block;

FIG. 4 is a perspective view illustrating a state of the conducting wire and the connection terminal in the usage mode of FIG. 2 together with some components of the terminal block;

FIG. 5 is an exploded perspective view of the terminal block;

FIG. 6 is a perspective view of an elastic member as viewed from above;

FIG. 7 is a perspective view of the elastic member as viewed from below;

FIG. 8 is a side view of the elastic member;

FIG. 9 is a plan view of the elastic member;

FIG. 10 is a rear view of the elastic member;

FIG. 11 is a perspective view illustrating an installation state of the elastic member and an energizing member inside the terminal block;

FIG. 12 is a perspective view illustrating an installation state of the elastic member and the energizing member inside the terminal block;

FIG. 13 is a front view illustrating the installation state illustrated in FIGS. 11 and 12;

FIG. 14 is a plan view illustrating an installation state illustrated in FIGS. 11 and 12;

FIG. 15 is a perspective view illustrating a mechanism for holding the connection terminal in the gap, the perspective view corresponding to the usage mode illustrated in FIG. 1;

FIG. 16 is a perspective view illustrating a mechanism for holding the connection terminal in the gap, the perspective view corresponding to the usage mode illustrated in FIG. 2;

FIG. 17 is a plan view of FIG. 16;

FIG. 18 is a cross-sectional view taken along line A-A of FIG. 17;

FIG. 19 is a cross-sectional view taken along line B-B in FIG. 17;

FIG. 20 is a perspective view of an elastic member according to another embodiment of the present embodiment as viewed from above;

FIG. 21 is a perspective view of an elastic member according to another embodiment of the present embodiment as viewed from below;

FIG. 22 is a side view of an elastic member according to another embodiment of the present embodiment;

FIG. 23 is a plan view corresponding to FIG. 17 of the lock mechanism and the elastic member according to another embodiment of the present embodiment;

FIG. 24 is a cross-sectional view of the lock mechanism and the elastic member taken along line A-A of FIG. 23 according to another embodiment of the present embodiment;

FIG. 25 is a cross-sectional view of the lock mechanism and the elastic member taken along line B-B in FIG. 23 according to another embodiment of the present embodiment;

FIG. 26 is an exploded perspective view illustrating joining of the lock mechanism, the elastic member, and the energizing member according to another embodiment of the present embodiment;

FIG. 27 is a perspective view illustrating joining of the lock mechanism, the elastic member, and the energizing member according to another embodiment of the present embodiment;

FIG. 28 is a side view illustrating joining of the lock mechanism, the elastic member, and the energizing member according to another embodiment of the present embodiment; and

FIG. 29 is a diagram illustrating a modification of the present embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

However, in the method 1) described above, in addition to requiring complicated work such as screw fixing, the position of the connection terminal tends to be unstable until screw fixing, and since work needs to be performed with both hands, both hands cannot be used, and there is a problem that work efficiency decreases, and further, it is necessary to manage screw tightening torque. Furthermore, in a case where it is necessary to attach and detach the connection terminal to and from the terminal block for maintenance inspection or other reasons, attachment and detachment work of a screw is required each time of attachment and detachment, and there is also a problem that work efficiency is very poor. On the other hand, the method of the above 2) is excellent as compared with the method of the above 1) in that the screw fixing is unnecessary and the work of attaching and detaching the connection terminal to and from the terminal block is simplified. However, in general, the gap for inserting the connection terminal is positioned in the vicinity of the bottom plate of the terminal block. For this reason, the work of visually confirming the gap position is complicated. In addition, when the connection terminal is inserted into the gap, it is necessary for the user to move the hand holding the conducting wire along the bottom plate of the terminal block unnaturally, and there is a problem that it is difficult to perform the insertion work.

An object of the present disclosure is to provide a terminal block that solves the problems of the related-art terminal block.

In order to solve the above problem, according to an aspect of the present disclosure, there is provided a terminal block capable of connecting a plate-shaped connection terminal provided at one end of a conducting wire gripped by a user during connection work, the terminal block including: a housing; an energizing member installed in the housing, the energizing member having a surface erected toward a connection work side of the connection terminal by the user; and an opposing member provided in the housing in a state of opposing the surface, the opposing member forming, between the opposing member and the surface, a gap into which the connection terminal is inserted, the gap being opened on a connection work side of the connection terminal by the user, in which the connection terminal is inserted into the gap along an insertion direction with one plate surface of the connection terminal facing the surface.

According to the terminal block of this aspect, since the gap into which the connection terminal is inserted is opened on the connection work side of the connection terminal by the user, the user can easily visually confirm the position of the gap, and when the connection terminal is inserted into the gap, it is only necessary to move the hand holding the conducting wire from the connection work side where the user is located toward the gap, so that the insertion work can be easily performed.

According to the present disclosure, there is provided a terminal block in which a position of a gap into which a connection terminal is inserted can be easily confirmed visually and insertion work can be easily performed.

Hereinafter, an exemplary embodiment for carrying out the present disclosure will be described in detail with reference to the drawings. However, dimensions, materials, shapes, relative positions of components, and the like described in the following embodiments are arbitrary unless they are essential matters for the present disclosure, and can be changed according to the configuration of the apparatus to which the present disclosure is applied or various conditions. The scope of the present disclosure is not limited to the embodiments specifically described below.

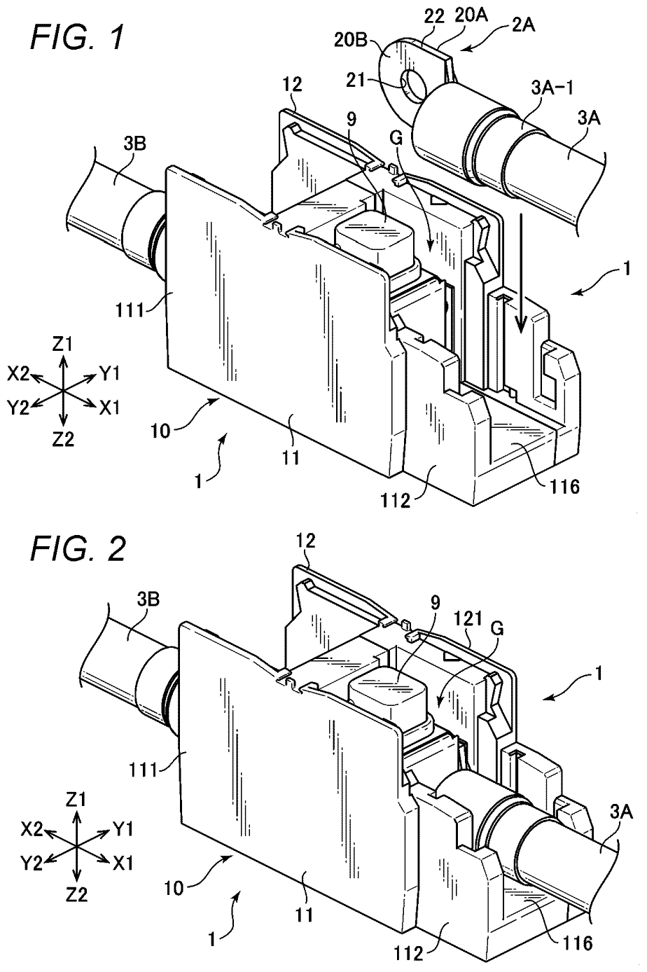

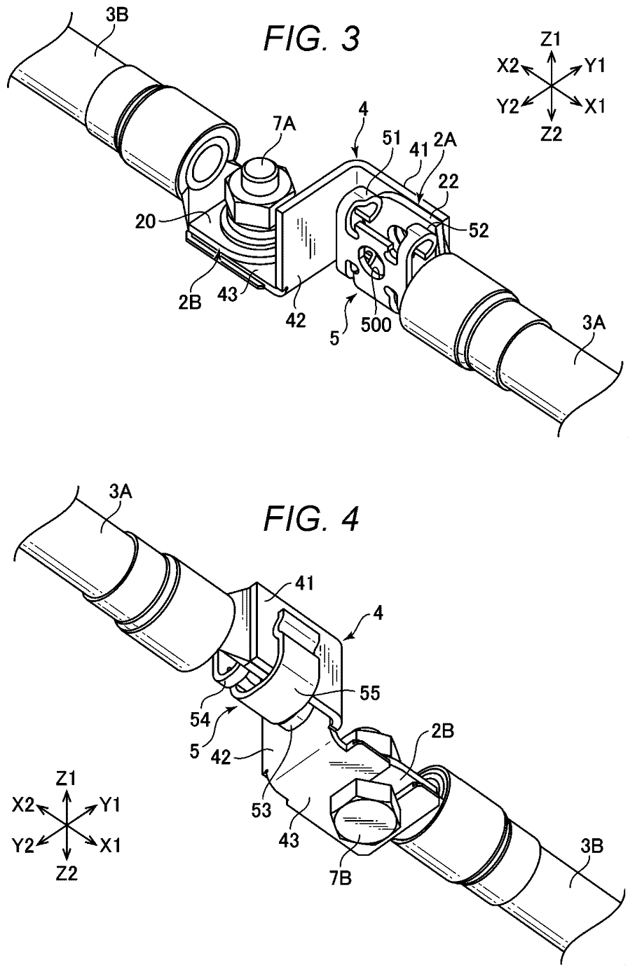

FIGS. 1 and 2 are perspective views illustrating an example of a usage mode of a terminal block according to an embodiment of the present disclosure, and FIGS. 3 and 4 are perspective views illustrating states of a conducting wire and a connection terminal in the usage mode of FIG. 2 together with some components of the terminal block. FIG. 3 is a perspective view seen from above, and FIG. 4 is a perspective view seen from below.

To be sure, these drawings are not intended to limit an installation direction of a terminal block 1. For example, FIGS. 1 and 2 do not intend that the terminal block 1 needs to be horizontally installed on a floor surface or an attachment base forming a horizontal installation surface, and merely illustrate an example of an installation direction. For example, the terminal block 1 may be installed vertically on a wall surface forming a vertical installation surface. Therefore, the term “height direction” or the like used in the following description should be understood to include various directions such as a “depth direction” according to the installation direction of the terminal block 1.

The terminal block 1 can be connected to two plate-shaped connection terminals 2A and 2B provided at ends of conducting wires 3A and 3B, for example, two commercially available round terminals each provided with a through hole 21 at a center. The conducting wires 3A and 3B are respectively led out from the connection terminals 2A and 2B in “X1” and “X2” directions, and both extend along the “X” direction. The conducting wire 3A and the conducting wire 3B can be energized through connection between the connection terminals 2A and 2B and the terminal block 1. For the sake of convenience, in the present embodiment, the connection terminal 2A and the connection terminal 2B have the same size and shape. However, in order to implement the present embodiment, it is sufficient that the connection terminal 2A is a plate-shaped terminal provided with the through hole 21, and the connection terminal 2A does not necessarily have a round shape, and it is not necessary to provide the through hole 21 in a case where locking is unnecessary. On the other hand, the connection terminal 2B is connected by a related-art method as disclosed in JP-A No. 2002-343460, and thus the shape and the like thereof are not limited. However, the terminal block is changed so that the connection can be made in the same manner as the connection terminal 2A.

The connection terminal 2A in FIG. 1 indicates a state in which the connection terminal 2A is not connected to the terminal block 1, in other words, a state at the time of connection work (during connection work), while the connection terminal 2B indicates a state in which the connection terminal 2B has been connected to the terminal block 1, in other words, a state after the connection work is completed. On the other hand, FIGS. 2 to 4 illustrate a state in which both of the connection terminals 2A and 2B have been connected to the terminal block 1.

The connection terminal 2A is inserted into a gap “G” provided in the terminal block 1 and elastically held therein by being moved, for example, along a height direction “Z” from a connection work side (“Z1” side) on which a user is located toward the terminal block 1 side (“Z2” side) in a state where a part of the conducting wire 3A, for example, a portion indicated by 3A-1 is gripped by the user, in other words, by extending a hand downward such that the direction “X” in which the conducting wire 3A led out from the connection terminal 2A extends and the direction “Z” along the connection work of the connection terminal 2A by the user are substantially orthogonal. At this time, the conducting wire 3A is moved in the direction “Z” along the connection work of the connection terminal 2A by the user, and the direction “Z” along the connection work is substantially parallel to a surface 40A. “Substantially orthogonal” is described because the connection work is basically performed by a human, and therefore cannot be completely orthogonal. The connection terminal 2A is moved in a direction shown in FIG. 1, more specifically, in a state where plate surfaces 20A and 20B of the connection terminal 2A are substantially parallel to a surface (X-Z surface) formed by the moving direction “Z2” of the connection terminal 2A.

Similarly to the connection terminal 2A, the connection terminal 2B is also moved from the connection work side (“Z1” side) where the user is located toward the terminal block 1 side (“Z2” side) in a state where a part of the conducting wire 3B is gripped by the user. However, unlike the connection terminal 2A, the connection terminal 2B is moved substantially in parallel so as to be brought into surface contact with the connection surface of the terminal block 1, in other words, the plate surfaces 20A and 20B of the connection terminal 2B is moved substantially in parallel with the surface (X-Y surface) substantially orthogonal to the moving direction “Z2” of the connection terminal (similar to Patent Literature 1). After bringing the connection terminal 2B into surface contact with the connection surface of the terminal block 1, the connection terminal 2B is fixed to the terminal block 1 using screws 7A and 7B provided in a state of penetrating a hole 21 provided at the center. The reason why the connection terminal 2B is fixed with the screws is that the connection terminal 2B is basically not assumed to be removed unlike the connection terminal 2A. On the other hand, since the connection terminal 2A may be removed in order to release the conductive state for the purpose of periodic inspection or the like, the connection terminal 2A is attached to the terminal block 1 by a method different from the connection terminal 2B.

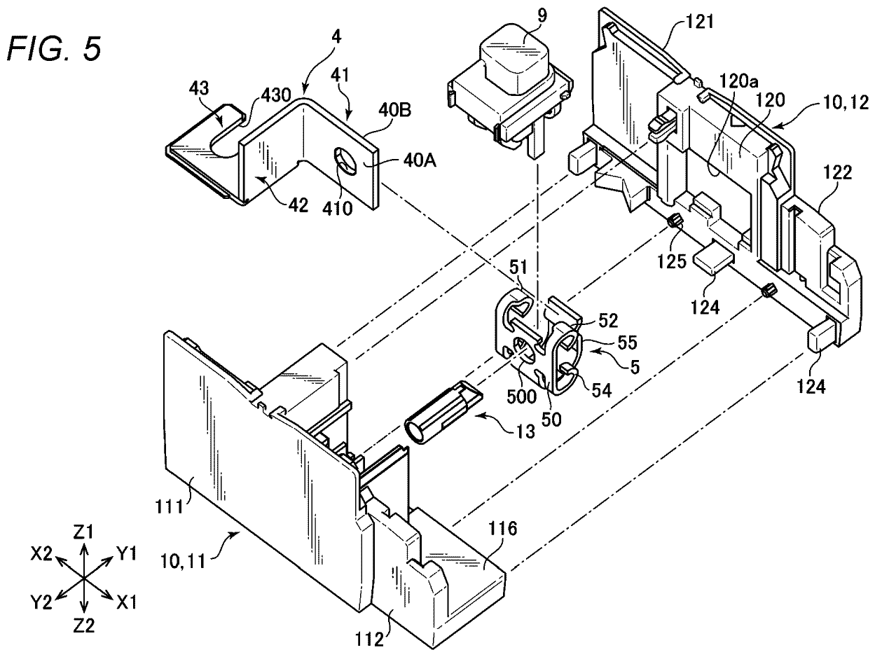

FIG. 5 is an exploded perspective view of the terminal block. The terminal block 1 includes a housing 10 and a plurality of components installed in the housing 10, that is, an energizing member 4, an elastic member 5, and lock mechanisms 9 and 13.

The housing 10 includes two parts.

A first part 11 includes side plates 111 and 112 forming side walls of the terminal block 1 and a bottom plate 116 installed on an installation surface, and a second part 12 includes only side plates 121 and 122. The first part 11 and the second part 12 can be combined with each other in a width direction “Y” orthogonal to the height direction “Z”. The combination is maintained by means of locking parts 124, 125 provided on the side plates 121, 122 of the second part 12 and corresponding locking parts (not shown) provided on the side of the first part 11.

The side plates 111 and 112 configuring the first part 11 are erected in the “Z1” direction toward the connection work side of the connection terminals 2A and 2B by the user in a state of being connected at a right angle to the side edge of the bottom plate 116 along the length direction “X” orthogonal to the height direction “Z” and the width direction “Y”. The side plate 111 is set to be large in the length direction “X” and the height direction “Z”, and the side plate 112 is set to be small. All the components of the terminal block 1 are placed on the side plate 111 and the bottom plate portion connected thereto. On the other hand, the side plate 112 and the bottom plate portion coupled to the side plate 112 receive a part of the conducting wire 3A connected to the connection terminal 2A along the length direction “X” in an attachable and detachable state.

The side plate 121 configuring the second part 12 has the same size as the side plate 111 in length direction “X” and height direction “Z”, and the side plate 122 has the same size as the side plate 112. The inner wall 120 of the side plate 121 is provided with a recessed portion 120a in which a part of the energizing member 4 (plate-shaped member 41) and a part of the elastic member 5 (a part of an elastic arm 55) are embedded in a fixed state. The side plate 122 receives a part of the conducting wire 3A connected to the connection terminal 2A along the length direction “X” in an attachable and detachable state together with the side plate 112 and the bottom plate portion coupled thereto.

The energizing member 4 is a member that electrically connects the connection terminal 2A and the connection terminal 2B, and includes three plate-shaped members 41 to 43 having a substantially square shape. These three plate-shaped members 41 to 43 are connected such that sides of adjacent plate-shaped members are perpendicular to each other.

The plate-shaped member 41 is installed in the housing 10 in a state of being erected in the “Z1” direction toward the connection work side of the connection terminal 2A by the user. One plate surface 40B side of the plate-shaped member 41 along the “X-Z plane” is embedded in a state of being fixed to the recessed portion 120a provided in the side plate 121 of the second part 12, and similarly, the other plate surface 40A along the “X-Z plane” forms one side of the gap “G” into which the connection terminal 2A is inserted. At the center of the plate-shaped member 41, a through hole 410 capable of receiving a distal end of the lock member 13 that locks the connection terminal 2A inserted into the gap “G” to the terminal block 1 is provided. Note that the through hole 410 only may receive the connection terminal 2A, and thus does not necessarily penetrate, and may be a bottomed recess.

Similarly to the plate-shaped member 41, the plate-shaped member 42 is installed in the housing 10 in a state of being erected in the “Z1” direction toward the connection work side of the connection terminal 2A by the user and in a state of forming a plate surface along the “Y-Z plane”. The plate-shaped member 42 is connected to each of the plate-shaped member 41 and the plate-shaped member 43 at sides adjacent to each other.

Unlike the plate-shaped members 41 and 42, the plate-shaped member 43 is installed in the housing 10 in a state of being in surface contact with the bottom plate 116 of the housing 10 and in a state of forming a plate surface along the “X-Y surface”. The plate-shaped member 43 is provided with a U-shaped notch 430 that bites into one side in order to allow a screw to penetrate when the connection terminal 2B is screwed.

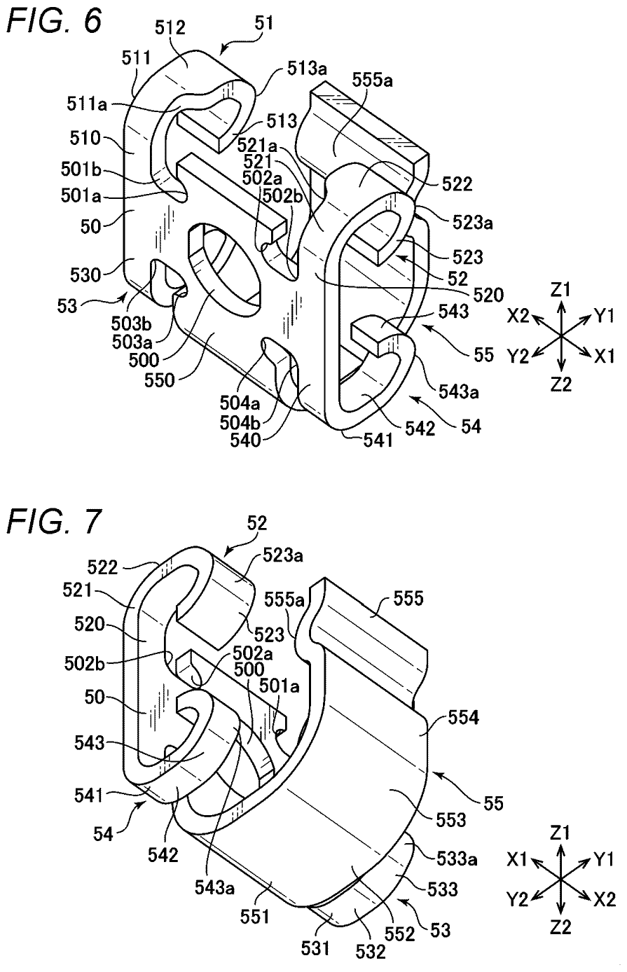

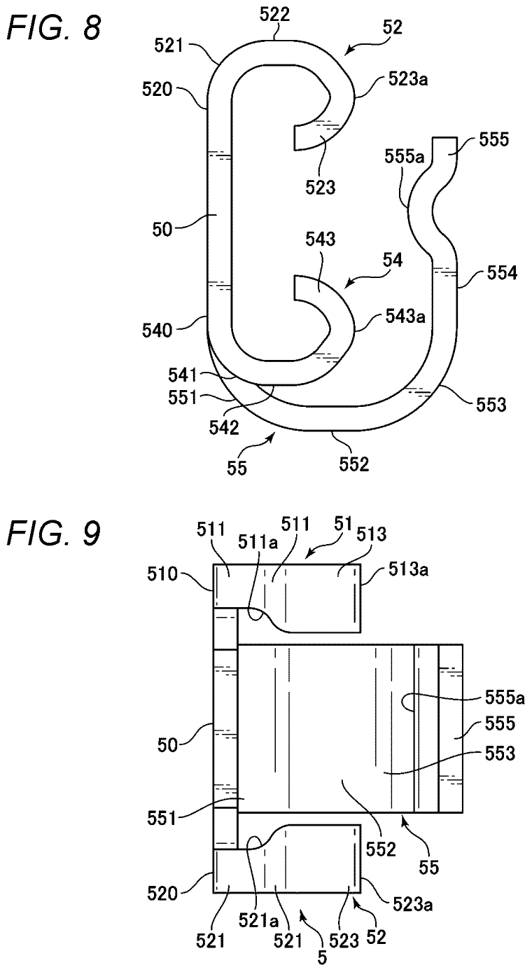

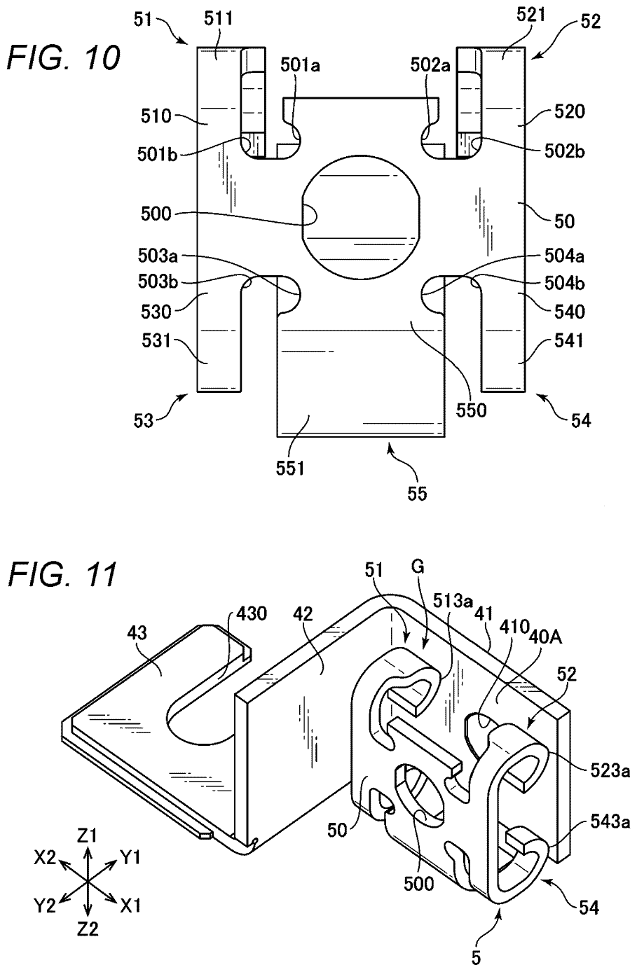

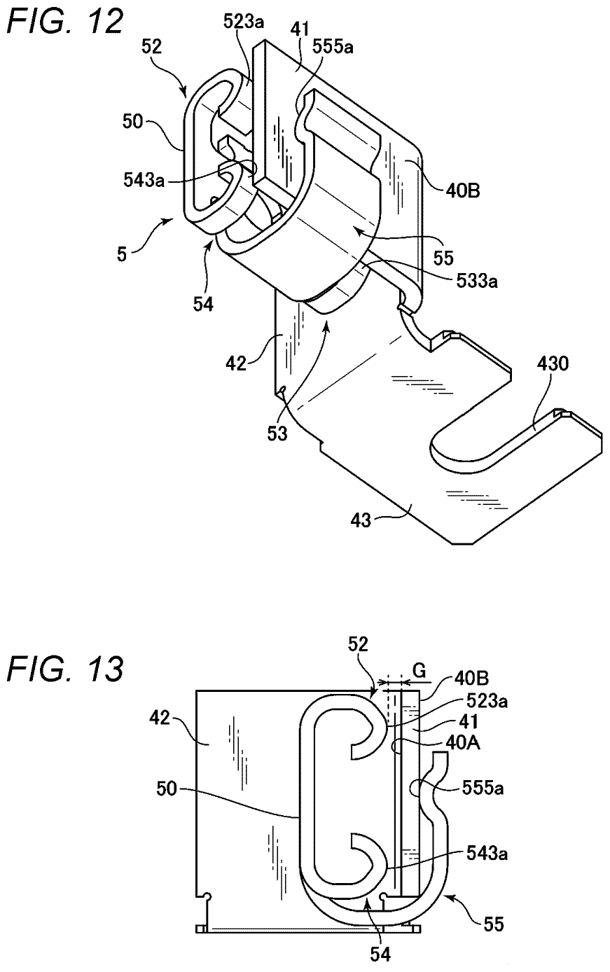

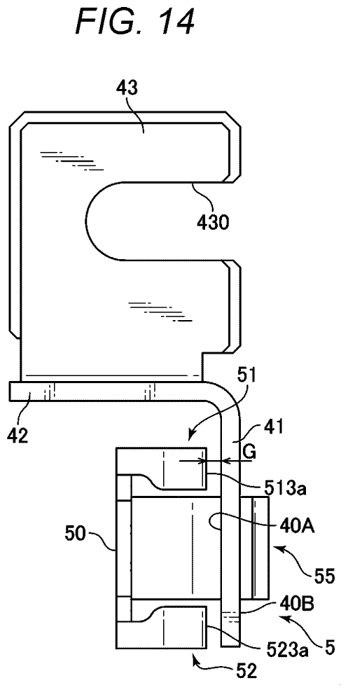

FIGS. 6 to 10 illustrate individual views of the elastic member, and FIGS. 11 to 14 illustrate installation states of the elastic member and the energizing member inside the terminal block. FIG. 6 is a perspective view of the elastic member as viewed from above, FIG. 7 is a perspective view as viewed from below, FIG. 8 is a side view, FIG. 9 is a plan view, and FIG. 10 is a rear view. FIG. 11 is a perspective view of an installed state as viewed from above, FIG. 12 is a perspective view as viewed from below, FIG. 13 is a front view, and FIG. 14 is a plan view.

The elastic member 5 is formed by cutting and bending metal, and has a symmetrical shape in a plane “X-Z” formed by a length direction “X” and a height direction “Z”. The elastic member 5 includes a base body 50 having a substantially rectangular plate shape, four opposing members 51 to 54 provided on the base body 50, and the elastic arm 55 similarly provided on the base body 50. A through hole 500 through which the above-described lock member 13 passes is provided at the center of the base body 50. The elastic arm 55 is fixed to the recessed portion 120a of the side plate 121 together with the plate-shaped member 41 of the energizing member 4, and elastically supports the base body 50, more specifically, the four opposing members 51 to 54 provided in the base body 50.

The opposing members 51 to 54 are provided in a state of protruding in a direction “Y1” perpendicular to the plate surface, in other words, toward the plate surface 40A of the plate-shaped member 41 configuring the energizing member 4 from the vicinity of the corner portions of the four corners of the base body 50.

The opposing member 51 includes a protrusion 513 and connecting portions 510 to 512 which connect the base body 50 and the protrusion 513 to each other. The distal end of the protrusion 513 forms a contact 513a that comes into contact with the connection terminal 2A inserted into the gap “G”. The connecting portions 510 to 512 include a substantially linear connecting portion 510 from the base body 50 toward the protrusion 513, a curved connecting portion 511 having a wide portion 511a toward the distal end, and a substantially linear connecting portion 512 in this order. In order to disperse the stress when the contact 513a of the protrusion 513 comes into contact with the connection terminal 2A, a curved notch 501b is provided in the vicinity of the base of the connecting portion 510 directly connected to the base body 50 and the base body 50. For the same reason, a curved notch 501a is also provided in a portion closer to the center “X1” in the length direction of the notch 501b. The notch 501a mainly serves to effectively prevent a crack that may occur between the base body 50 and the through hole 500, and the notch 501b mainly serves to effectively prevent a crack that may occur in the base body 50.

The opposing members 52 to 54 have the same configuration as the opposing member 51. Therefore, detailed description is omitted. In the following description and drawings, for the opposing member 52, the reference numbers 520s are used for the protrusions, and the reference numeral 502 is used for the notch. Similarly, for the opposing member 53, the reference numerals 530s and the reference numeral 503 are used, and for the opposing member 54, the reference numerals 540s and the reference numeral 504 are used.

The elastic arm 55 extends in a protruding direction “Y1” in which the opposing members 51 to 54 protrude from between the pair of opposing members 53 and 54 separated in the length direction “X” and “Z1” toward the connection work side of the connection terminal 2A by the user while being curved in a substantially C shape so as to surround one side of the energizing member 4, and includes a substantially linear connecting portion 550, a curved portion 551, a substantially linear connecting portion 552, a curved portion 553, and a substantially linear connecting portion 554 in this order.

By curving and extending in a substantially C shape, an abutting portion 555 provided at a distal end of the elastic arm 55 reaches the opposing side of contacts 513a to 543a in the direction “Y” along the protruding direction “Y1” in a state where the plate-shaped member 41 of the energizing member 4 is sandwiched between the abutting portion 555 and the contacts 543a to 543a and abuts on one plate surface 40B of the plate-shaped member 41. An abutting area 555a of the abutting portion 555 with the plate surface 40B has a predetermined width along the moving direction “Z2” of the connection terminal 2A, in other words, along the direction “X” orthogonal to the insertion direction “Z2” of the connection terminal 2A, in an in-plane “X-Z plane” orthogonal to the protruding direction “Y1”. Therefore, the abutting portion 555 stably abutting on the plate surface 40B and abutting on the plate surface 40B does not enter the through hole 410 provided in the plate-shaped member 41.

The contacts 513a to 543a provided at the distal ends of the protrusions 513 to 543 are arranged on the opposing side of the plate surface 40A, and form a gap “G” into which the connection terminal 2A is inserted between the contacts and the plate surface 40A. Since the gap “G” is opened on the user's connection work side of the connection terminal 2A, the user can easily view the position of the gap “G” and easily perform the insertion work. These contacts 513a to 543a are also arranged substantially point-symmetrically with respect to the abutting area 555a of the elastic arm 55 in an in-plane “X-Z plane” orthogonal to the protruding direction “Y1”. Further, the contacts 513a to 543a are arranged substantially symmetrically with respect to the through hole 500 provided in the base body 50.

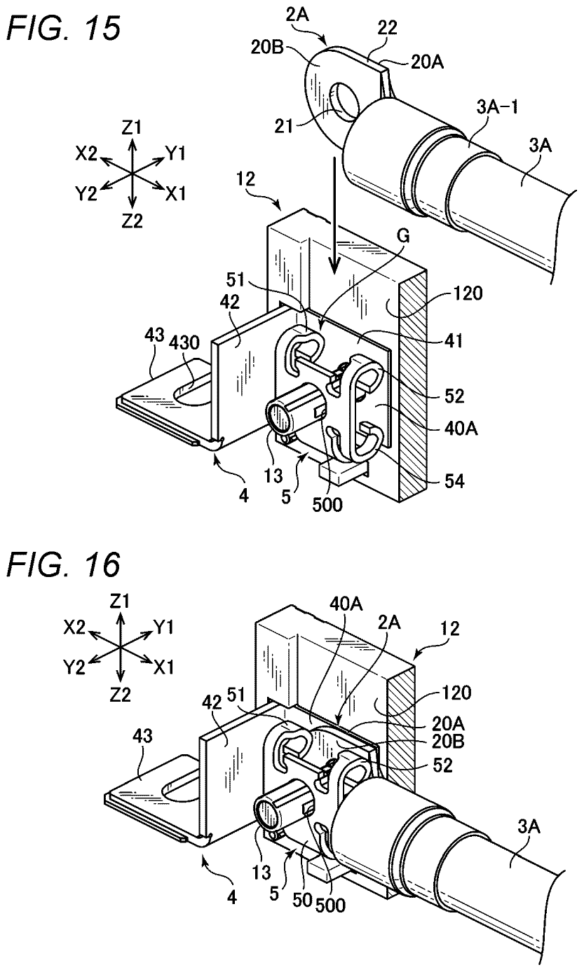

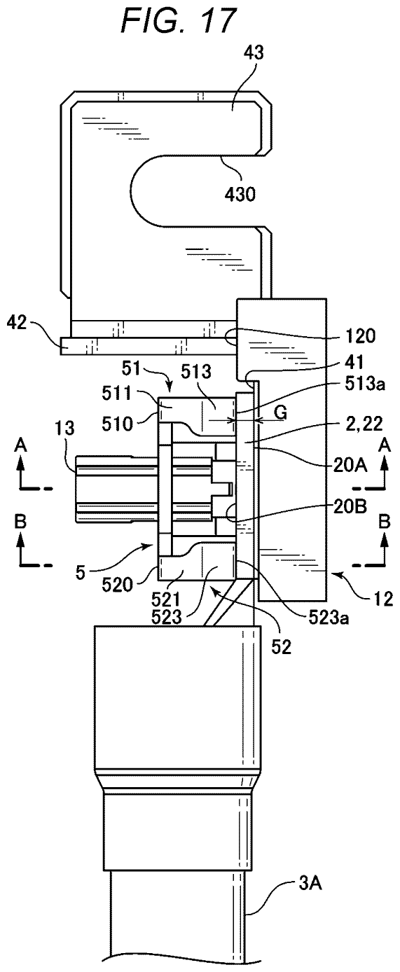

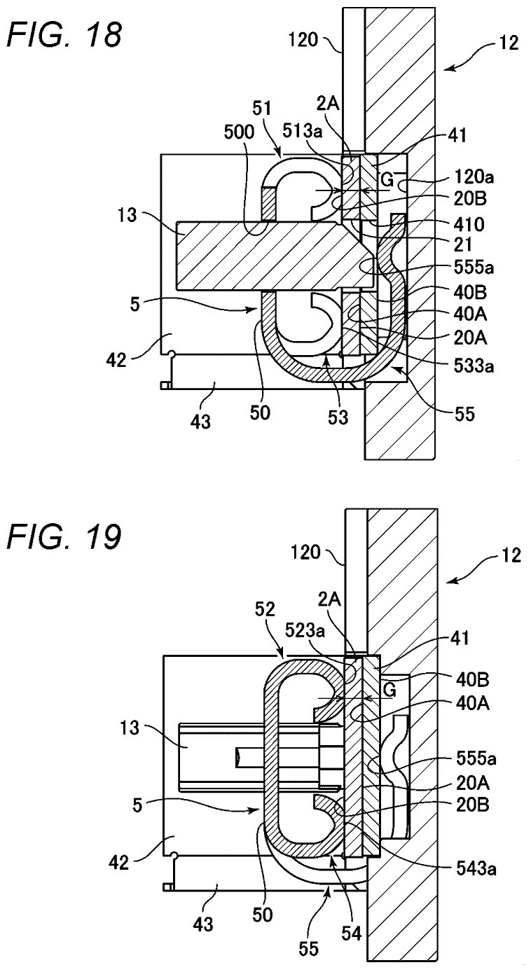

A mechanism for holding the connection terminal in the gap will be described with reference to FIGS. 15 to 19. FIG. 15 is a perspective view corresponding to the use mode illustrated in FIG. 1, and illustrates the conducting wire and the connection terminal in a state of not being connected to the terminal block together with some components of the terminal block. FIG. 16 is a perspective view corresponding to the use mode illustrated in FIG. 2 and illustrates the same member in a state of being connected to the terminal block. FIG. 17 is a plan view of FIG. 16, FIG. 18 is a cross-sectional view taken along line A-A of FIG. 17, and FIG. 19 is a cross-sectional view taken along line B-B of FIG. 17.

The connection terminal 2A is inserted into the gap “G” formed between the contacts 513a to 543a provided in the opposing members 51 to 54 and the plate surface 40A in a posture along the “X-Z plane”, in other words, in a state where the one plate surface 20A of the connection terminal 2A faces the gap “G” such that the direction “Z” along the connection work of the connection terminal 2A by the user is substantially parallel to the plate surface 40A (in a state where the surface 22 having a plate thickness is directed in the insertion direction “Z2”). As a result, the connection terminal 2A comes into surface contact with the plate surface 20A at the plate surface 40A, and the connection terminal 2A and the energizing member 4 are electrically connected.

In a case where the connection terminal 2A having a plate thickness larger than the plate thickness of the gap “G” in the direction “Y” along the protruding direction “Y1” is inserted into the gap “G”, the base body 50 located on the opposite side of the elastic arm, that is, the contacts 513a to 543a of the opposing members 51 to 54 supported by the base body 50 are elastically displaced in the direction “Y2” opposite to the protruding direction “Y1” in which the opposing members 51 to 54 protrude by the action of the elastic arm. By the action of the elastic arm 55, the connection terminal 2A is elastically held in the gap “G”. As described above, since the contacts 513a to 543a are arranged substantially point-symmetrically with respect to the abutting area 555a of the elastic arm 55 in the “X-Z plane” in the plane orthogonal to the protruding direction “Y1”, the force received by the connection terminal 2A at the abutting area 555a is uniformly distributed on the plate surface 20B of the connection terminal 2A, and thus the connection terminal 2A is elastically held in a stable state in the gap “G”.

The connection terminal 2A inserted into the gap “G” is locked at a predetermined position using the lock mechanisms 9 and 13. The locking is performed by allowing a rod-like lock member 13, which is provided in a state where a distal end thereof is previously made to pass through the through hole 500 provided in the base body 50 along the protruding direction “Y”, to pass through the through hole 21 of the connection terminal 2A. When the connection terminal 2A is inserted into the gap “G”, the lock member 13 can be made to pass through the through hole 21 of the connection terminal 2A along the protruding direction “Y” by operating the button-shaped lock device 9 or automatically. At this time, the distal end of the lock member 13 is received in the through hole 410 provided along the protruding direction “Y1” corresponding to the through hole 21 of the connection terminal 2A and the through hole 500 of the base body 50. The lock member 13 penetrating the through hole 21 can be unlocked and pulled out by operating the lock device 9. As for the lock mechanism using the lock member 13 and the lock device 9, a technique used in a related art can be used, and thus details are not described herein.

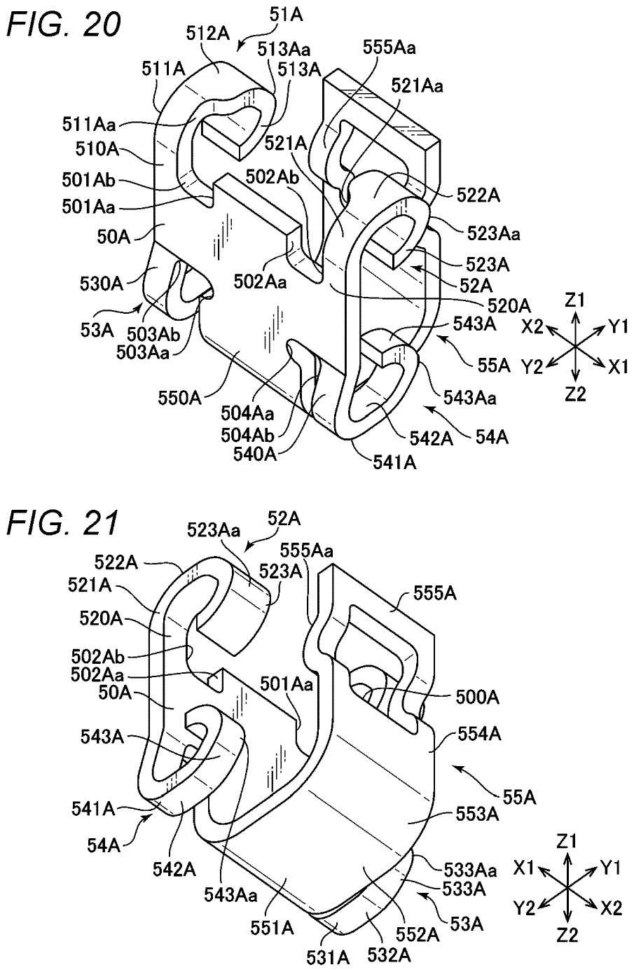

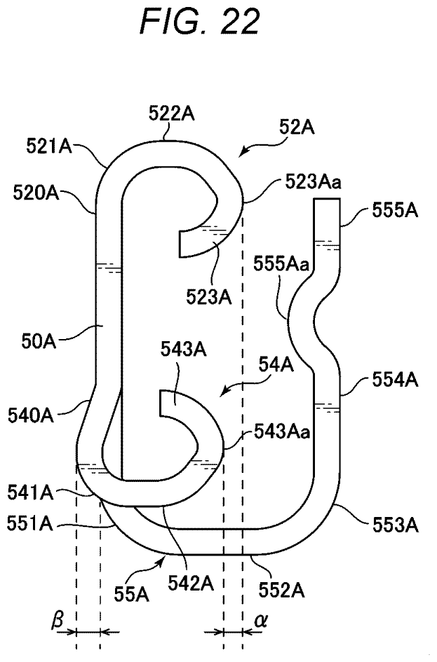

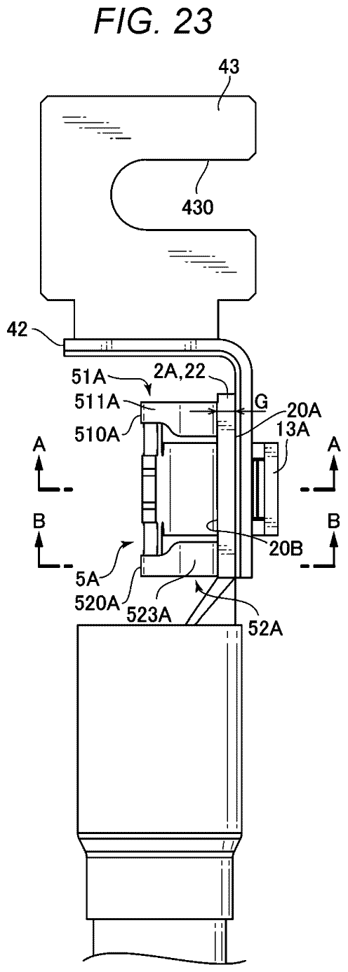

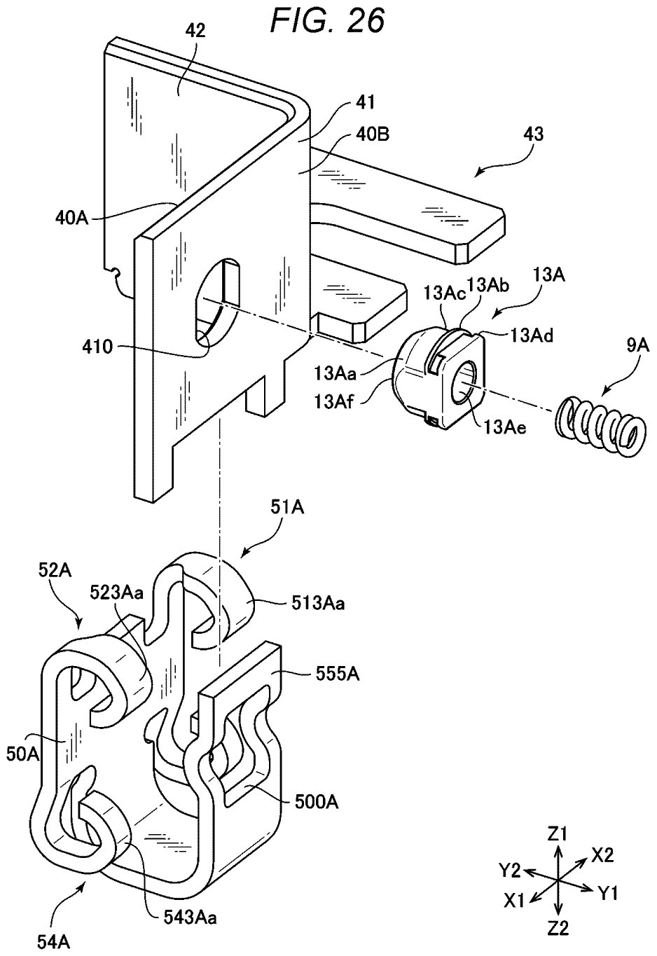

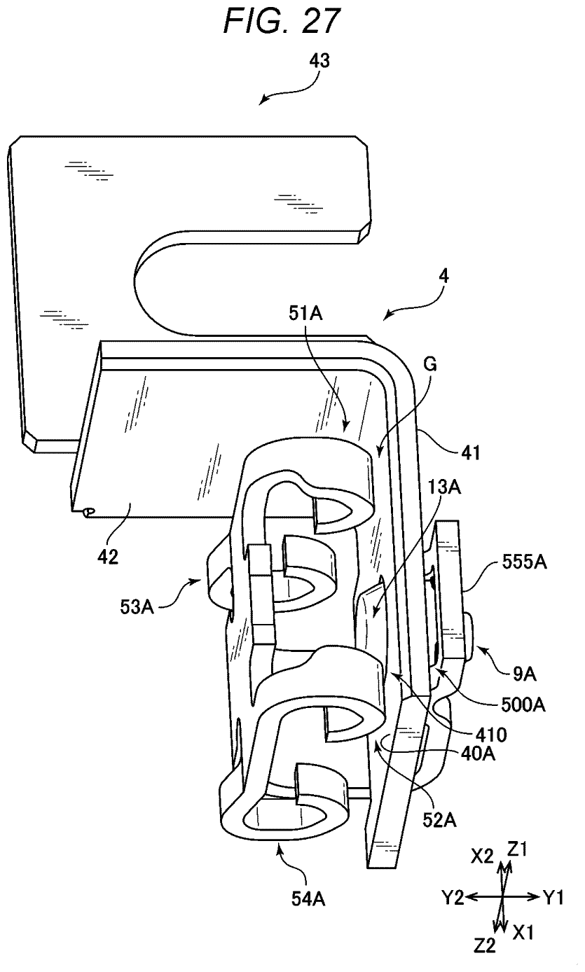

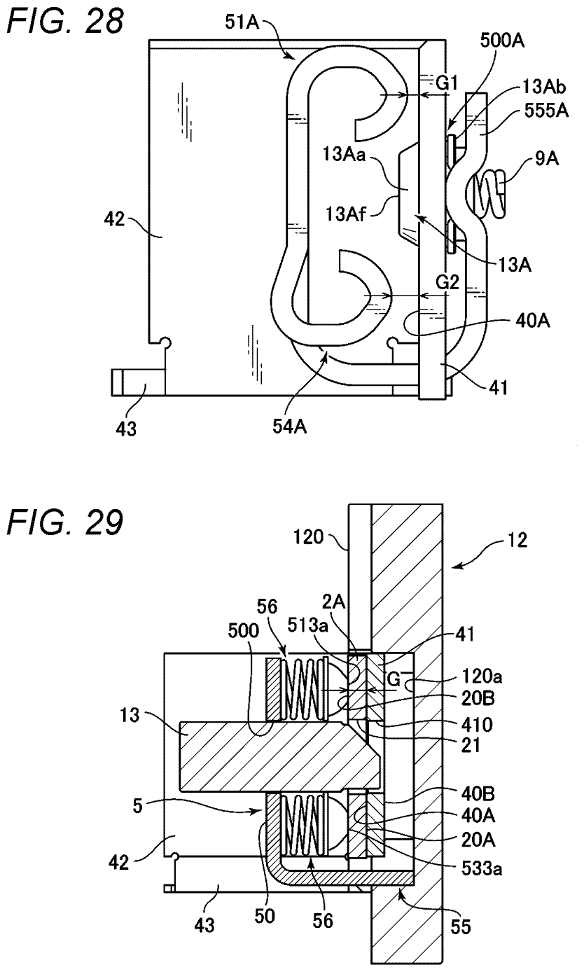

Another embodiment of the lock mechanism and the elastic member will be described with reference to FIGS. 20 to 28. FIGS. 20 to 22 correspond to the elastic members in FIGS. 6 to 8 of the embodiment described with reference to FIG. 1 and the like, respectively. Furthermore, FIGS. 23 to 25 correspond to the lock mechanism and the elastic member in FIGS. 17 to 19 of the embodiment described with reference to FIG. 1 and the like, respectively. FIG. 26 is an exploded perspective view illustrating joining of the lock mechanism, the elastic member, and the energizing member. FIG. 27 is a top perspective view of a state before the connection terminal is inserted between the elastic member and the plate-shaped member. FIG. 28 shows a side view thereof. In these drawings, members similar to those in the embodiment described with reference to FIG. 1 and the like are denoted by the same reference numerals. In the following description, matters that are not described may be considered to be the same as those in the embodiment described with reference to FIG. 1 and the like.

In the present embodiment, unlike the lock mechanism using the lock member 13 and the lock device 9 illustrated in FIG. 1 and the like, a change is made so that the lock member 13A is inserted not in the “Y1” direction but in the “Y2” direction. As well shown in FIGS. 23 to 28, the lock mechanism of the present embodiment includes a lock member 13A and a spring-like elastic member 9A. The lock member 13A and the spring-like elastic member 9A are positioned in a small gap between an elastic member 5A and a side wall 121 (see FIG. 5 and the like) of a housing 10. Thus, the lock member 13A is formed shorter in the “Y” direction than the lock member 13.

The lock member 13A includes a large-diameter main body 13Ac, a truncated conical distal end 13Aa provided on the distal end side of the main body 13Ac, a rectangular rear end 13Ad provided on the rear end side of the main body 13Ac, and a stopper 13Ab having a partially annular flange shape provided between the main body 13Ac and the rear end 13Ad. The main body 13Ac is provided with a bottomed hole 13Ae communicating with the through hole of the stopper 13Ab from the rear end toward the distal end side. A distal end surface 13Af is formed in the truncated conical distal end 13Aa.

The elastic member 9A is installed on the rear end side of the lock member 13A. The distal end of the elastic member 9A is inserted into and installed in a bottomed hole 13Ae provided in the main body 13Ac. The rear end of the elastic member 9A is installed on the side wall 121 (see FIG. 5 and the like) of the housing 10. The elastic member 9A constantly biases the lock member 13A from the “Y1” side toward the “Y2” side.

In a state of being biased by the elastic member 9A, the lock member 13A is installed in a state of penetrating a through hole 500A provided at the center of a distal end of an elastic arm 555A and a through hole 410 provided in a plate-shaped member 41 of an energizing member 4. At this time, the distal end 13Aa penetrates the through hole 500A and the through hole 410 and further protrudes from the through hole 410 (see FIG. 28 and the like). In addition, the stopper 13Ab is fixed to the plate-shaped member 41 in a state of being butted against one plate surface 40B of the plate-shaped member 41 by the action of the elastic member 9A.

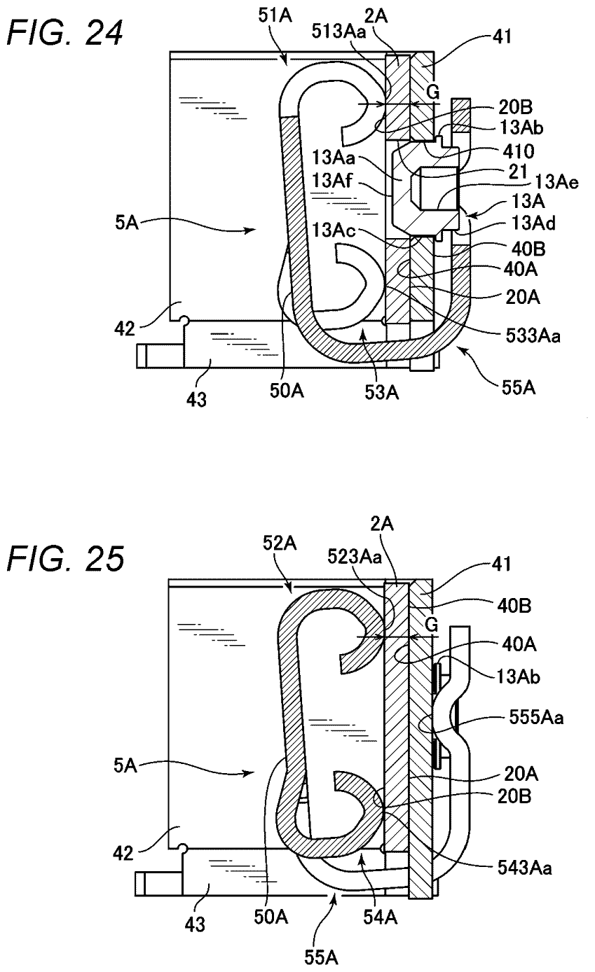

When the connection terminal 2A is inserted into the gap “G” and reaches a side surface of the distal end 13Aa, a distal end 13Aa moves in the “Y1” direction against the biasing force of the elastic member 9A through the collision with the connection terminal 2A. Thereafter, the distal end 13Aa moves in the “Y1” direction until the distal end surface 13Af of the distal end 13Aa reaches the completely same position as an inner wall 40A of a plate-shaped member 41 in the “Y” direction, and when a through hole 21 of a connection terminal 2A is aligned with the through hole 500A in the “Y” direction, the distal end 13Aa moves in the “Y2” direction to an original position by a biasing force of the elastic member 9A and is disposed inside the through hole 21 of the connection terminal 2A (see FIG. 24). As a result, the connection terminal 2A inserted into the gap “G” is locked at a predetermined position.

In the present embodiment, for the purpose of improving the insertion performance of the connection terminal, a change is made to a relationship between opposing members 51A and 52A of the elastic member 5A and opposing members 53A and 54A. Specifically, as well illustrated in FIGS. 20 to 22, among the pair of opposing members 51A and 53A of a base body 50A separated from each other in the direction “Z” along the insertion direction “Z2”, a contact 513Aa of the opposing member 51A arranged on a front side in an insertion direction “Z2” is provided in a state of protruding in the “Y1” direction by a distance “α” from a contact 533Aa of the opposing member 53A arranged on a back side in the insertion direction “Z2”, and similarly, among the pair of opposing members 52A and 54A of the base body 50A separated from each other in the direction “Z” along the insertion direction “Z2”, a contact 523Aa of the opposing member 52A arranged on the front side in the insertion direction “Z2” is provided in a state of protruding in the “Y1” direction by a distance “α” from the contact 543Aa of the opposing member 54A disposed on a back side in the insertion direction “Z2”. In other words, the contacts 533Aa and 543Aa are provided in a state of being retracted in the “Y2” direction by the distance “α” from the contacts 513Aa and 523Aa. When the connection terminal 2A is inserted into a gap “G1” (see FIG. 28) formed between the contacts 513Aa and 523Aa and the plate surface 40A, the contacts 513Aa and 523Aa move in the “Y2” direction through the contact with the connection terminal 2A. In addition, with this movement, the base body 50A is inclined in the “Y2” direction around the connecting portion 550A and the curved portion 551A of the elastic arm 555A, and as a result, the contacts 533Aa and 543Aa move in the “Y1” direction. As in the embodiment illustrated in FIG. 1 and the like, in a case where the contacts 513Aa, 523Aa and the contacts 533Aa, 543Aa are positioned at the same position in the “Y” direction, a gap “G2” (see FIG. 28) formed between the contacts 533Aa, 543Aa and the plate surface 40A becomes narrower than the gap “G1” formed between the contacts 513Aa, 523Aa and the plate surface 40A by the movement of the contacts 533Aa and 543Aa in the “Y1” direction, and thus a large force is required by the insertion of the connection terminal 2A into the gap “G2”. On the other hand, as in the present embodiment, in a case where the contacts 533Aa and 543Aa are provided in a state of being retracted in the “Y2” direction in advance from the contacts 513Aa and 523Aa, even when the contacts 533Aa and 543Aa move in the “Y1” direction, it is possible to reduce the degree of narrowing the gap “G2” formed between the contacts 533Aa and 543Aa and the plate surface 40A, and as a result, it is possible to reduce a force for inserting the connection terminal 2A. Therefore, this configuration has an effect of improving insertion performance of the connection terminal.

Although the above configuration is useful for improving the insertion performance of the connection terminal, in a case where the contacts 533Aa and 543Aa are simply retracted in the “Y2” direction, the spring lengths of the opposing members 53A and 54A become shorter than the spring lengths of the opposing members 51A and 52A. As a result, the force received from the opposing members 53A and 54A when the connection terminal 2A is inserted into the gap “G2” becomes larger than the force received from the opposing members 51A and 52A when the connection terminal 2A is inserted into the gap “G1”. In other words, it is difficult to insert the connection terminal 2A into the gap “G2”. In order to solve this problem, in the present embodiment, not only the contacts 533Aa and 543Aa are simply retracted in the “Y2” direction, but also the opposing members 53A and 54A are changed so that the spring lengths of the opposing members 53A and 54A are increased. More specifically, the connecting portions (531A and 530A, 540A and 541A) of the opposing members 53A and 54A with the base body 50A are provided in a state of protruding from the base body 50A by a distance “B” in the direction “Y2”. According to this configuration, the spring lengths of all the opposing members 51A, 52A, 53A, and 54A can be made substantially the same. With this configuration, not only the contacts 513Aa and 523Aa and the contacts 533Aa and 543Aa can be positioned at substantially the same position in the “Y” direction as in the embodiment illustrated in FIG. 1 and the like, but also the forces received by the user at the contacts 533Aa and 543Aa and the contacts 513Aa and 523Aa can be made substantially equal when the connection terminal 2A is inserted. That is, even if the distances “α” and “B” are provided in the elastic member 5A, the same insertion state as in the embodiment illustrated in FIG. 1 and the like can be obtained. Therefore, the user can more smoothly insert the connection terminal 2A into the gap “G”. Therefore, this configuration has an effect of improving insertion performance of the connection terminal.

Note that the present disclosure is not limited to the above-described embodiments, and various other modifications can be made. For example, in the present embodiment, the elastic action of the elastic member 5 is exerted by the elastic arm 55, but as illustrated in the modification of FIG. 29 corresponding to the cross-sectional view of FIG. 18, the elastic action can be exerted by a member other than the elastic arm 55. In this modification, instead of using the elastic arm 55, the opposing members 51 to 54 are provided with a winding spring 56 which is an elastic member. According to this modification, the elastic arm 55 is unnecessary.

Still other aspects, features and advantages of the present disclosure will become readily apparent from the following detailed description, given only by way of a number of specific embodiments and examples, including the best mode contemplated for carrying out the disclosure. The present disclosure can also be configured in other and different embodiments, and its numerous details can be varied in various obvious respects without departing from the spirit and scope of the disclosure. Therefore, the drawings and the description are merely examples, and are not limited thereto.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A terminal block for connecting a plate-shaped connection terminal provided at one end of a conducting wire gripped by a user during connection work, the terminal block comprising:
a housing;
an energizing member installed in the housing, the energizing member having a surface erected toward a connection work side of the connection terminal by the user; and
an opposing member provided in the housing in a state of opposing the surface, the opposing member forming, between the opposing member and the surface, a gap into which the connection terminal is inserted, the gap being opened on a connection work side of the connection terminal by the user, wherein
the connection terminal is inserted into the gap along an insertion direction with one plate surface of the connection terminal facing the surface.

2. The terminal block according to claim 1, wherein the connection terminal is elastically held in the gap.

3. The terminal block according to claim 1, wherein the opposing member protrudes toward the surface and forms a contact in contact with the connection terminal inserted into the gap at a distal end of the opposing member.

4. The terminal block according to claim 3, wherein the opposing member is provided on an elastic member, and
the elastic member includes:
a base body provided with the opposing member; and
an elastic arm that extends in a curved manner in a substantially C shape in a protruding direction in which the opposing member protrudes from between a pair of opposing members of the base body separated from each other in a direction in which the conducting wire led out from the connection terminal extends when the connection terminal is inserted into the gap and toward the connection work side of the connection terminal by the user, the elastic arm including an abutting portion that can hold the energizing member in a state of being sandwiched between the abutting portion and a contact on an opposing side of the contact in a direction along the protruding direction, the abutting portion being configured to abut on an opposing surface of the energizing member facing the surface of the energizing member in a direction along the protruding direction, and to allow the opposing member provided on the base body to be elastically displaced in a direction opposite to the protruding direction.

5. The terminal block according to claim 3, wherein
the opposing member is provided on an elastic member, and
the elastic member includes:
a base body provided with the opposing member; and
an elastic arm extending in a protruding direction in which the opposing member protrudes from the base body and extending in a curved manner in a substantially C shape toward a connection work side of the connection terminal by the user,
the elastic arm includes an abutting portion that can hold the energizing member in a state of being sandwiched between the abutting portion and the contact on an opposing side of the contact in a direction along the protruding direction, and the abutting portion is configured to abut on an opposing surface of the energizing member opposing the surface of the energizing member in the direction along the protruding direction, and to elastically displace the opposing member provided on the base body in a direction opposite to the protruding direction, and
the contact of the opposing member disposed on a front side in the insertion direction among the opposing members of the pair of base bodies separated from each other in the direction along the insertion direction is provided in a state of protruding in the protruding direction from the contact of the opposing member disposed on a back side in the insertion direction.

6. The terminal block according to claim 5, wherein a connecting portion of the opposing member disposed on a back side in the insertion direction to the base body protrudes.

7. The terminal block according to claim 4, wherein an abutting area of the abutting portion abutting on the opposing surface has a predetermined width along a direction orthogonal to the insertion direction in a plane orthogonal to the protruding direction.

8. The terminal block according to claim 4, wherein the plurality of contacts is arranged substantially point-symmetrically with respect to an abutting area of the abutting portion abutting on the opposing surface in a plane orthogonal to the protruding direction.

9. The terminal block according to claim 4, wherein a corresponding through hole is formed in the base body to correspond to a lock member penetrating the through hole of the connection terminal inserted into the gap.

10. The terminal block according to claim 5, wherein a corresponding through hole is formed in the base body to correspond to a lock member penetrating the through hole of the connection terminal inserted into the gap.

11. The terminal block according to claim 4, wherein a corresponding through hole is provided in the elastic arm to correspond to a lock member penetrating through the through hole of the connection terminal inserted into the gap.

12. The terminal block according to claim 5, wherein a corresponding through hole is provided in the elastic arm to correspond to a lock member penetrating through the through hole of the connection terminal inserted into the gap.

13. The terminal block according to claim 9, wherein a through hole or a bottomed recess for receiving a part of the lock member along the protruding direction is provided on the surface of the energizing member to correspond to the through hole provided in the connection terminal and the corresponding through hole provided in the base body.

14. The terminal block according to claim 10, wherein a through hole or a bottomed recess for receiving a part of the lock member along the protruding direction is provided on the surface of the energizing member to correspond to the through hole provided in the connection terminal and the corresponding through hole provided in the base body.

15. The terminal block according to claim 9, wherein the plurality of contacts is arranged substantially symmetrically with respect to the corresponding through hole in a plane orthogonal to the protruding direction.

16. The terminal block according to claim 10, wherein the plurality of contacts is arranged substantially symmetrically with respect to the corresponding through hole in a plane orthogonal to the protruding direction.

17. The terminal block according to claim 1, wherein when the connection terminal is inserted into the gap, a direction in which the conducting wire led out from the connection terminal extends and a direction along a connection work of the connection terminal by the user are substantially orthogonal to each other.

18. The terminal block according to claim 1, wherein when the connection terminal is inserted into the gap, the conducting wire led out from the connection terminal is moved in a direction along a connection work of the connection terminal by the user.

19. The terminal block according to claim 1, wherein when the connection terminal is inserted into the gap, a direction along connection work of the connection terminal by the user is substantially parallel to the surface.

20. The terminal block according to claim 1, wherein the energizing member includes three plate-shaped members in which adjacent sides are connected to each other at a right angle.
